(19) United States
(12) Patent Application Publication
(10) Pub. No.: US 2011/0075453 A1
(43) Pub. Date: Mar. 31, 2011

(54) DYNAMIC CONVERSION OF VARIABLE VOLTAGE DC TO AC

(75) Inventor: Perry S. Schugart, Dousman, WI (US)

(73) Assignee: American Superconductor Corporation, Devens, MA (US)

(21) Appl. No.: 12/957,501

(22) Filed: Dec. 1, 2010

(51) Int. Cl. H02M 7/44

(52) U.S. Cl. 363/65

(57) ABSTRACT

An apparatus for power conversion includes an inverter; a converter configurable to function as a DC voltage booster; and a controller for selectively causing the converter to provide a boosted DC voltage to the inverter.

### FIELD OF DISCLOSURE

This disclosure relates to electric power conditioning, and in particular, to converting DC into AC.

### BACKGROUND

Many modes of generating or storing electricity involve generation and storage of a DC voltage. For example, voltages maintained across an energy storage element, such as a battery or capacitor, and voltage developed across a fuel cell of solar cell, are all typically DC voltages.

Electric power utilities typically require AC voltages, not DC voltages. Accordingly, it is common to provide a source of DC voltage with a device, such as an inverter, for converting DC to AC.

A typical inverter uses an input DC voltage level to generate AC having a specified amplitude with a peak not exceeding the input DC voltage level. Thus, an inverter provided with a high DC voltage can generate an AC output waveform having a high amplitude. Conversely, an inverter provided with only a low DC voltage level will only be able to generate a low AC voltage output. Such an inverter would no longer be able to generate the high AC voltage output that it could when it was receiving a higher DC voltage as an input. Instead, it would output a “clipped” AC waveform.

Most electric power utilities require, from a power generating source, an AC voltage having a particular amplitude. In some cases, a DC voltage source cannot develop a DC voltage sufficient to provide an AC voltage having the requisite amplitude. For example, in the case of a solar cell, this may occur at dusk or dawn, or when passing clouds obscure the sun. In the case of an energy storage device, this might occur when the stored charge is close to exhausted.

A DC source that fails to develop sufficient voltage to satisfy the requirements of a utility grid is nevertheless still generating power. However, this power is essentially wasted.

### SUMMARY

In one aspect, the invention features an apparatus for power conversion. Such an apparatus includes an inverter; a converter configurable to function as a DC voltage booster; and a controller for selectively causing the converter to provide a boosted DC voltage to the inverter.

In some embodiments, the controller is configured to cause the converter to transition from a first state, in which the converter converts DC into AC, to a second state, in which the converter converts DC into boosted DC. Among these embodiments are those that also include a set of contactors, the set having a first subset of contactors and a second subset of contactors, the second subset of contactors being the complementary subset of the first subset of contactors, wherein the controller is configured to transition between the first state and the second state by causing a change in state of all contactors in the first subset and causing a change in state in all contactors of the second subset. Also among these embodiments are those in which the controller is configured to transition between the first state and the second state by opening all contactors in the first subset and closing all contactors in the second subset.

In other embodiments, the apparatus also includes a common bus connecting a DC terminal of the inverter to a DC terminal of the converter. Among these embodiments are those that further include a first contactor for selectively connecting the common bus to a DC source, and those in which the controller is configured to close the first contactor, thereby enabling DC voltage to be provided as DC inputs to the inverter and the converter, and to open the first contactor, thereby disconnecting the inverter from the DC source.

In yet other embodiments, the apparatus further includes a voltage sensor in communication with the controller for determining a DC voltage, with the controller being configured to selectively cause the converter to provided the boosted DC voltage to the inverter upon determining that a DC voltage has crossed a threshold.

In another aspect, the invention features an apparatus for causing AC having a specified amplitude to be generated from DC having a variable voltage level. Such an apparatus includes means for determining whether a first DC voltage level is sufficient to generate the AC having the specified amplitude; and means for selectively boosting the first voltage level to a second DC voltage level in response to a determination, from the means for determining, that the first voltage level is inadequate for generating the AC having the specified amplitude.

In some embodiments, the means for determining includes a controller in communication with a sensor for measuring, or determining, a voltage level.

Other embodiments include those in which the means for selectively boosting includes a controller configured to control an inverter, and those in which the means for selectively boosting includes a plurality of contactors, with the plurality having first and second configurations, in which the second configuration causes a DC voltage to be boosted.

In another aspect, the invention features a method for generating AC having a specified amplitude from DC having a variable voltage level. Such a method includes determining that a DC voltage provided by a DC source has a DC voltage level that is inadequate to generate the AC; boosting the DC voltage; providing the boosted DC voltage to an inverter for conversion into the AC; determining that the DC voltage level provided by the DC source has become adequate to generate the AC; and providing the DC voltage from the DC source to the inverter for conversion into AC.

Among the practices of the foregoing method are those in which providing the boosted DC voltage to an inverter includes disconnecting the inverter from the DC source, and those in which providing the boosted DC voltage level to an inverter includes disconnecting an inverter from an AC output,

Also among the practices of the foregoing method are those in which boosting the DC voltage level includes causing a converter to switch from generating an AC voltage from a DC voltage to generating a first DC voltage from a second DC voltage, those in which boosting the DC voltage level includes dynamically reconfiguring a connection between the inverter and the DC voltage, and those in which boosting the DC voltage level includes carrying out double-conversion of the DC voltage, and wherein providing the DC voltage from the DC source to the inverter includes carrying out single-conversion of the DC voltage.

These and other features of the invention will be apparent from the following detailed description and the accompanying figures, in which:

### DESCRIPTION OF THE FIGURES

FIG. 1 shows a DC-AC inverter system;

FIG. 2 shows the DC-AC inverter system of FIG. 1 configured for operation when insufficient voltage has been developed by the DC power source; and

FIG. 3 shows the DC-AC inverter system of FIG. 1 configured for operation when sufficient voltage is developed by the DC power source.

### DETAILED DESCRIPTION

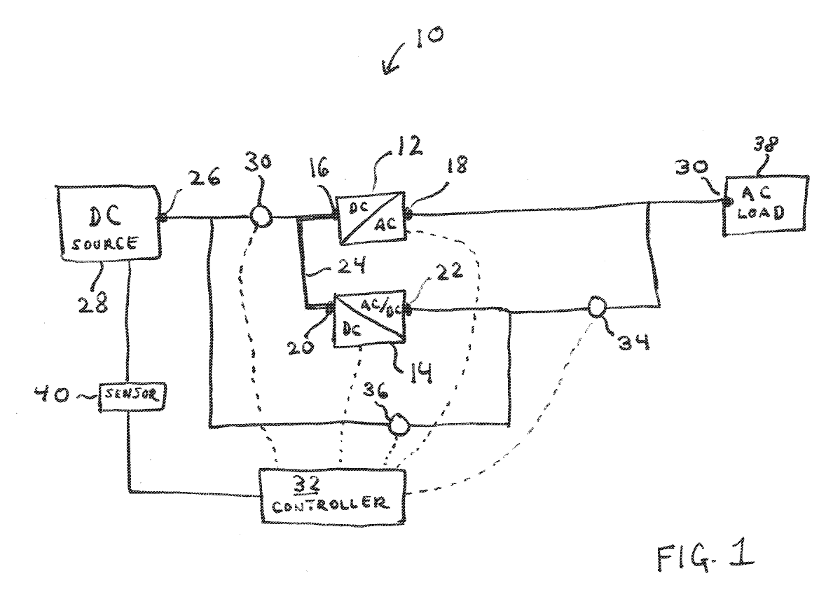

Referring to FIG. 1, a DC-AC conversion system 10 converts a DC voltage from a DC source 28 into an AC voltage for an AC load 38. Examples of a DC source 28 include a solar array, a fuel cell, a battery, and a capacitor. An example of an AC load 38 is an electric power grid.

One embodiment of a DC-AC conversion system 10 includes an inverter 12 and a converter 14, both of which can convert DC into AC. As is well known, an inverter is a species of power converter. Many power converters can be configured to convert DC into AC, as well as many other power conversion functions. Thus, the inverter 12 can, in some embodiments, be implemented by a multi-function power converter that is configured to operate as an inverter, i.e. to convert DC into AC. However, in some embodiments, the inverter 12 is implemented by a device that can only convert DC into AC.

The converter 14 is implemented by a multifunctional unit that can also convert DC at a first voltage into DC at a second voltage, with the second voltage being greater than the first voltage. Thus, the inverter 12 has a DC terminal 16 and at least an AC terminal 18, whereas the converter 14 has a DC terminal 20 and an AC/DC terminal 22. A common bus 24 connects the DC terminal 16 of the inverter 12 and the DC terminal 20 of the converter 14.

An input terminal 26 of the DC-AC conversion system 10 provides a connection between the common bus 24 and a DC voltage source 28 by way of a first contactor 30 that can be selectively opened and closed by a controller 32.

An output terminal 30 of the conversion system 10 directly connects to the AC terminal 18 of the inverter 12. The output terminal 30 of the conversion system 10 also connects to the AC/DC terminal 22 of the converter 14, but via a second contactor 34 that is selectively opened and closed by the controller 32. Finally, the AC/DC terminal 22 of the converter 14 also connects to the input terminal 26 of the DC-AC conversion system 10 by way of a third contactor 36. Like the first and second contactors 30, 34, the third contactor 36 can also be selectively opened and closed by the controller 32.

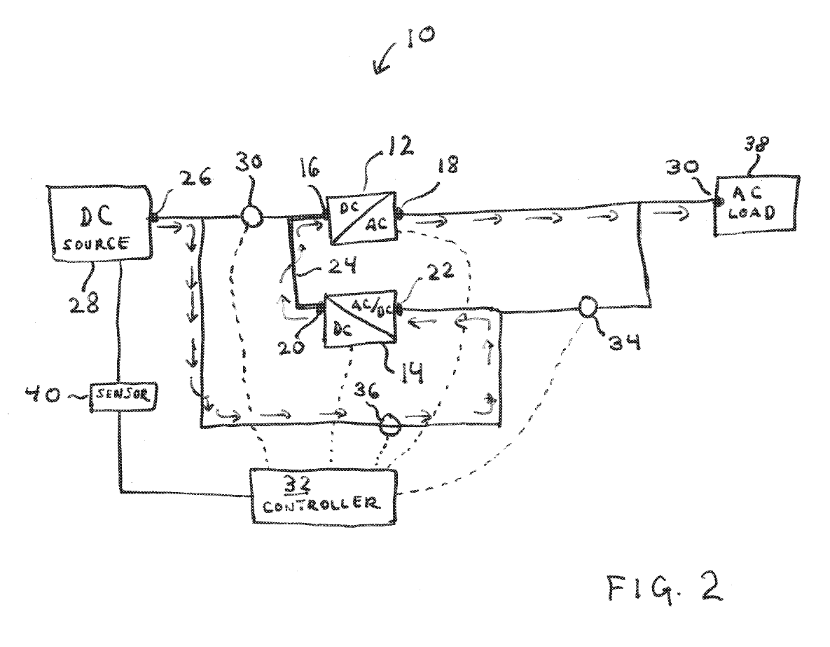

When the DC voltage is inadequate to support an AC waveform having the required amplitude, the controller 32 causes the DC-AC conversion system 10 to operate in “double-conversion mode,” as shown in FIG. 2. To do so, the controller 32 closes the third contactor 36 but leaves the first and second contactors 30, 34 open. In addition, the controller 32 configures the converter 14 to boost an input DC voltage.

In double-conversion mode, the DC source 28 provides a DC voltage to the AC/DC terminal 22 of the converter 14. The converter 14, having been programmed to do so by the controller 32, boosts this DC voltage and provides it to the DC terminal 16 of the inverter 12. The inverter 12 then uses this boosted DC voltage to generate an output AC voltage having the required amplitude.

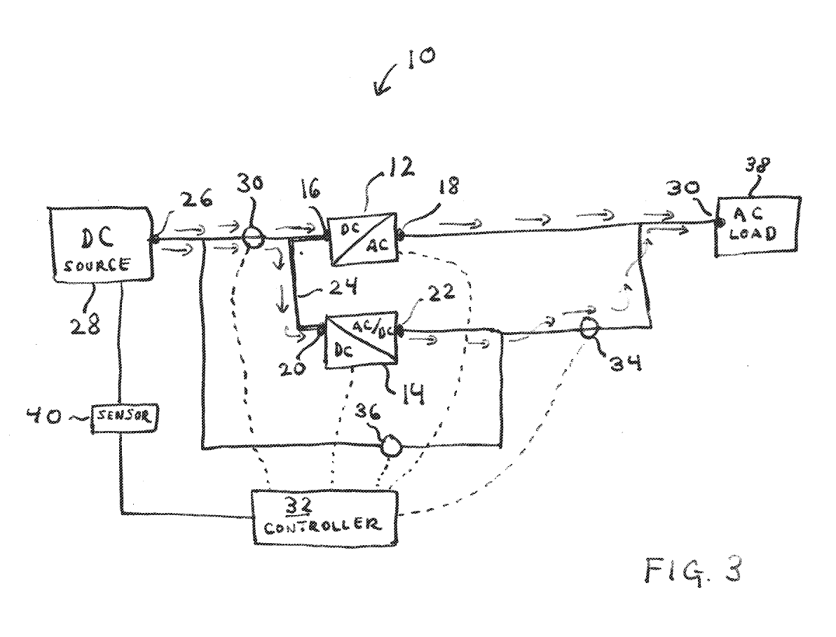

When the DC voltage is adequate to support an AC waveform having the required amplitude, the controller 32 causes the DC/AC conversion system 10 to operate in “single-conversion mode,” as shown in FIG. 3. In single-conversion mode, the controller 32 closes the first and second contactors 30, 34 but leaves the third contactor 36 open. In addition, the controller 32 configures the converter 14 to generate AC from DC.

The DC boosting process carried out by the converter 14 in double-conversion mode is inherently an inefficient one. By adaptively switching between the two conversion modes, the system 10 avoids having to carry out the inefficient DC boosting process except when rendered necessary by the unavailability of adequate DC voltage for generating an AC voltage waveform having the required amplitude.

The inverter 12 and the converter 14 are rated to have a particular power-handling capacity. Typically, the rating of a single inverter is inadequate to handle the power generated by the DC source when operating at or near full capacity. For this reason, a DC-AC conversion system 10 would ordinarily have two or more inverters that cooperate to generate the required AC voltage. Accordingly, the DC-AC converter system 10 would require an inverter 12 and a converter 14 anyway just to handle the power generated by the DC source, as well as a controller 32 to control the inverter 12 and the converter 14. Thus, other than three extra contactors, no additional hardware is required to implement the double-conversion mode. Instead, the second converter is simply used for a different function.

The particular topology of the embodiment described herein offers particular ease of implementation because switching from one mode to another amounts to switching the state of each contactor 30, 34, 36. The set of contactors 30, 34, 36 defines two subsets: a first subset containing only the third contactor 36 and a second subset containing only the first and second contactors 30, 34. As such, the second subset is a complementary subset of the first subset since the union of the first and second subsets defines the original set. Each contactor 30, 34, 36 is in one of two states: open or closed. Transition between states, at least in the illustrated embodiment, thus amounts to changing the state of each contactor from its current state to the opposite of its current state. This is particularly easy to implement on a controller 32 since it amounts to implementing a logical “NOT” operator on a register containing one bit for each contactor, with the state of the bit corresponding to the state of the contactor.

In some embodiments, a voltage sensor 40 in communication with the controller 32 determines whether the voltage provided by the DC source has fallen below a critical value. Based on a measurement provided by this sensor 40, the controller 32 automatically reconfigures the contactors 30, 34, 36 and inverters 12, 14 to operate in either single-conversion mode or double-conversion mode.

For example, in one embodiment, upon detecting that the voltage provided by the DC source has risen past the critical value, the controller 32 automatically reconfigures the contactors 30, 34, 36 and inverters 12, 14 to operate in single-conversion mode. Conversely, upon detecting that the voltage provided by the DC source has fallen below the critical value, the controller 32 automatically reconfigures the contactors 30, 34, 36 and inverters 12, 14 to operate in double-conversion mode. In either case, the transition occurs seamlessly and without human intervention.

The DC-AC conversion system 10 as described herein greatly extends the range over which a DC source can operate. For example, using the DC-AC conversion system 10 enables a solar array to continue providing power to a utility grid closer to dawn or dusk, during when it would normally no longer be providing such power.

Having described the invention, and a preferred embodiment thereof, what I claim as new, and secured by Letters Patent is:

1. An apparatus for power conversion, said apparatus comprising:
an inverter;
a converter configurable to function as a DC voltage booster; and
a controller for selectively causing said converter to provide a boosted DC voltage to said inverter.

2. The apparatus of claim 1, wherein said controller is configured to cause said converter to transition from a first state, in which said converter converts DC into AC, to a second state, in which said converter converts DC into boosted DC.

3. The apparatus of claim 1, further comprising a common bus connecting a DC terminal of said inverter to a DC terminal of said converter.

4. The apparatus of claim 3, further comprising a first contactor for selectively connecting said common bus to a DC source.

5. The apparatus of claim 4, wherein said controller is configured to close said first contactor, thereby enabling DC voltage to be provided as DC inputs to said inverter and said converter, and to open said first contactor, thereby disconnecting said inverter from said DC source.

6. The apparatus of claim 2, further comprising a set of contactors, said set having a first subset of contactors and a second subset of contactors, said second subset of contactors being the complementary subset of said first subset of contactors, wherein said controller is configured to transition between said first state and said second state by causing a change in state of all contactors in said first subset and causing a change in state in all contactors of said second subset.

7. The apparatus of claim 6, wherein said controller is configured to transition between said first state and said second state by opening all contactors in said first subset and closing all contactors in said second subset.

8. The apparatus of claim 1,
further comprising a voltage sensor in communication with said controller for determining a DC voltage, and
wherein said controller is configured to selectively cause said converter to provided said boosted DC voltage to said inverter upon determining that a DC voltage has crossed a threshold.

9. An apparatus for causing AC having a specified amplitude to be generated from DC having a variable voltage level, said apparatus comprising:
means for determining whether a first DC voltage level is sufficient to generate said AC having said specified amplitude; and
means for selectively boosting said first voltage level to a second DC voltage level in response to a determination, from said means for determining, that said first voltage level is inadequate for generating said AC having said specified amplitude.

10. The apparatus of claim 9, wherein said means for determining comprises a controller in communication with a sensor for measuring, or determining, a voltage level.

11. The apparatus of claim 9, wherein said means for selectively boosting comprises a controller configured to control an inverter.

12. The apparatus of claim 9, wherein said means for selectively boosting comprises a plurality of contactors, said plurality having first and second configurations, wherein said second configuration causes a DC voltage to be boosted.

13. A method for generating AC having a specified amplitude from DC having a variable voltage level, said method comprising:
determining that a DC voltage provided by a DC source has a DC voltage level that is inadequate to generate said AC;
boosting said DC voltage level;
providing said boosted DC voltage to an inverter for conversion into said AC;
determining that said DC voltage level provided by said DC source has become adequate to generate said AC; and
providing said DC voltage from said DC source to said inverter for conversion into AC.

14. The method of claim 13, wherein providing said boosted DC voltage to an inverter comprises disconnecting said inverter from said DC source.

15. The method of claim 13, wherein boosting said DC voltage level comprises causing a converter to switch from generating an AC voltage from a DC voltage to generating a first DC voltage from a second DC voltage.

16. The method of claim 13, wherein providing said boosted DC voltage level to an inverter comprising disconnecting the inverter from said DC source.

17. The method of claim 13, wherein boosting said DC voltage level comprises dynamically reconfiguring a connection between said inverter and said DC voltage.

18. The method of claim 13, wherein boosting said DC voltage level comprises carrying out double-conversion of said DC voltage, and wherein providing said DC voltage from said DC source to said inverter comprises carrying out single-conversion of said DC voltage.

19. The apparatus of claim 1, further comprising a photovoltaic array for providing said inverter with a DC voltage to be boosted.

20. The method of claim 13, wherein determining that a DC voltage provided by a DC source has a DC voltage level that is inadequate to generate said AC comprises receiving a DC voltage level from a photovoltaic array.
